(19) United States
(12) Patent Application Publication
(10) Pub. No.: US 2023/0268621 A1
(43) Pub. Date: Aug. 24, 2023

(54) RECHARGEABLE BATTERY

(71) Applicant: SK ON CO., LTD., Seoul (KR)

(72) Inventor: Sung Woo LEE, Daejeon (KR)

(21) Appl. No.: 18/083,961

(22) Filed: Dec. 19, 2022

(30) Foreign Application Priority Data
Jan. 21, 2022 (KR) 10-2022-0009323

(51) Int. Cl. H01M 50/533; H01M 50/105; H01M 50/536; H01M 50/54

(52) U.S. Cl. CPC H01M 50/533; H01M 50/54; H01M 50/105; H01M 50/536

(57) ABSTRACT

A rechargeable battery includes an electrode assembly including a plurality of electrodes stacked in a first direction, a pouch case defining an inner space in which the electrode assembly is accommodated, and including a first sheet member surrounding an upper portion of the electrode assembly and a second sheet member surrounding a lower portion of the electrode assembly, a plurality of electrode tabs drawn from the plurality of electrodes in a second direction, perpendicular to the first direction, and an electrode lead combined with the plurality of electrode tabs, extending in a direction, perpendicular to the first direction, and intersecting the second direction, and partially exposed to an exterior of the pouch case. The first sheet member and the second sheet member are bonded to each other with the electrode lead therebetween to form a sealing portion sealing the inner space.

### CROSS-REFERENCE TO RELATED APPLICATION(S)

This application claims benefit of priority to Korean Patent Application No. 10-2022-0009323 filed on Jan. 21, 2022 in the Korean Intellectual Property Office, the disclosure of which is incorporated herein by reference in its entirety.

### BACKGROUND

### 1. Field

The present disclosure relates to a technology related to a rechargeable battery, and more particularly, to a technology related to a pouch-type rechargeable battery.

### 2. Description of Related Art

In general, types of secondary batteries include nickel cadmium batteries, nickel hydrogen batteries, lithium ion batteries, and lithium ion polymer batteries. In addition to small products such as digital cameras, P-DVDs, MP3Ps, mobile phones, PDAs, Portable Game Devices, Power Tools and E-bikes, such secondary batteries are also applied to and used in large-sized products requiring high output such as electric vehicles and hybrid vehicles, power storage devices storing surplus generated power or new renewable energy, and power storage devices for backup.

Since secondary batteries are sometimes classified according to the structure of the electrode assembly of the anode/separator/cathode structure, typically, there may be provided a jelly-roll (wound type) electrode assembly having a structure in which long sheet-shaped positive electrodes and negative electrodes are wound with a separator interposed therebetween, a stack-type electrode assembly in which a plurality of anodes and cathodes cut in units of a predetermined size are sequentially stacked with a separator interposed therebetween, a stack/folding-type electrode assembly with a winding structure of bicells or full cells in which positive and negative electrodes of a predetermined unit are stacked with a separator interposed therebetween, and the like.

Recently, a pouch-type battery having a structure in which a stacked or stacked/folding type electrode assembly is embedded in a pouch-type battery case of an aluminum laminate sheet has attracted much attention due to low manufacturing costs, small weight, easy shape deformation, and the like, and also, the usage thereof is gradually increasing.

A pouch type secondary battery is configured to include an electrode assembly in which a positive electrode plate and a negative electrode plate are sequentially stacked with a separator interposed therebetween, and a battery case, a pouch exterior material for accommodating the electrode assembly. In this case, in the electrode assembly, a plurality of positive electrode tabs extending from a plurality of positive electrode plates, and a plurality of negative electrode tabs extending from a plurality of negative electrode plates are formed. The plurality of positive electrode tabs and the plurality of negative electrode tabs are welded to a positive electrode lead and a negative electrode lead, respectively, by an ultrasonic welder. In this case, the plurality of positive electrode tabs and the plurality of negative electrode tabs constitute an electrode tab, and the positive electrode lead and the negative electrode lead constitute an electrode lead.

FIG. 1 is a cross-sectional view of a pouch-type secondary battery 10 of the related art. Electrode tabs 13 extending from an electrode assembly 11 are gathered and welded to an electrode lead 14. The electrode lead 14 of the related art has a relatively thin plate shape, and extends in the same direction as the direction in which the electrode tabs 13 extend and is drawn out of a pouch 12. In this case, a space required for coupling between the electrode assembly 11 and the electrode lead 14 may be relatively large. For example, in FIG. 1, the length at which the electrode tabs 13 are gathered while extending to the electrode lead 14, the length required for welding the electrode tabs 13 and the electrode lead 14, the length required to avoid interference between the weld and a lead film 15, and the length required for sealing the electrode lead 14 and the pouch 12 increase the overall size of the secondary battery 10 despite not contributing to the capacity of the secondary battery 10, which leads to an obstacle in increasing the energy density of the secondary battery 10.

### SUMMARY

An aspect of the present disclosure is to increase the energy density of a pouch-type rechargeable battery. In detail, an aspect of the present disclosure is to increase the ratio of the size of an electrode assembly to the overall size of a rechargeable battery by improving the arrangement of electrode leads or the coupling method between electrode leads and electrode tabs.

A rechargeable battery includes an electrode assembly including a plurality of electrodes stacked in a first direction; a pouch case defining an inner space in which the electrode assembly is accommodated, and including a first sheet member surrounding an upper portion of the electrode assembly and a second sheet member surrounding a lower portion of the electrode assembly; a plurality of electrode tabs drawn from the plurality of electrodes in a second direction, perpendicular to the first direction; and an electrode lead combined with the plurality of electrode tabs, extending in a direction, perpendicular to the first direction, and intersecting the second direction, and partially exposed to an exterior of the pouch case. The first sheet member and the second sheet member are bonded to each other with the electrode lead therebetween to form a sealing portion sealing the inner space.

The plurality of electrode tabs may extend in a direction, perpendicular to one side of the electrode assembly, and the electrode lead may extend in parallel to the one side and is drawn out of the pouch case in an extension direction.

In the sealing portion, a terrace surrounding the electrode lead may be located in a direction perpendicular to the second direction from the electrode assembly.

The electrode lead may be provided in a form of a circular rod.

A coupling surface between the electrode lead and the plurality of electrode tabs may face a direction intersecting the first direction.

The plurality of electrode tabs may be stacked with each other to form a coupling portion coupled onto the electrode lead, and in the coupling portion, the plurality of electrode tabs may be stacked in a direction intersecting the first direction.

The plurality of electrode tabs may be partially wound along a portion of an outer circumferential surface of the electrode lead.

The electrode lead may extend in both directions, and both ends may be drawn out of the pouch case.

At least one of the plurality of electrode tabs may form a first tab group, at least one of the plurality of electrode tabs may form a second tab group, distinct from the first tab group, and the electrode lead may include a first electrode lead coupled to the first tab group and a second electrode lead coupled to the second tab group.

The first electrode lead and the second electrode lead may extend in the same direction and may be drawn out in the same direction from the pouch case.

The first electrode lead and the second electrode lead may extend in directions opposite to each other and may be drawn out in opposite directions from the pouch case.

The first tab group and the second tab group may be drawn out from a first side of the electrode assembly, and the first electrode lead and the second electrode lead may be disposed on the first side of the electrode assembly, extend in directions opposite to each other, and may be drawn out in opposite directions from the pouch case.

At least one of the plurality of electrode tabs may form a third tab group, at least one of the plurality of electrode tabs may form a fourth tab group, distinct from the third tab group, and the third tab group and the fourth tab group may be drawn out from a second side of the electrode assembly, the second side being opposite to the first side. The electrode lead may further include a third electrode lead and a fourth electrode lead disposed on the second side of the electrode assembly, and the third electrode lead and the fourth electrode lead may extend in directions opposite to each other, and may be drawn out in opposite directions from the pouch case.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a cross-sectional view of a pouch-type rechargeable battery of the related art;

FIG. 2 is a perspective view of a rechargeable battery according to an embodiment;

FIG. 3 is an exploded perspective view of a rechargeable battery according to an embodiment;

FIG. 4 illustrates a cross-section taken along line I-I′ of FIG. 1 in an embodiment;

FIGS. 5 and 6 respectively illustrate a detailed coupling structure between an electrode tab and an electrode lead in embodiments;

FIG. 7 illustrates that one electrode lead is led out in both directions of a rechargeable battery in an embodiment;

FIG. 8 illustrates a rechargeable battery in which two electrode leads are led out in different directions in an embodiment;

FIG. 9 illustrates that two electrode leads are both disposed on one side of an electrode assembly in an embodiment; and

FIG. 10 illustrates a rechargeable battery including four electrode leads according to an embodiment.

### DETAILED DESCRIPTION

The terms used in this document are general terms in consideration of functions in various embodiments of the present disclosure. However, these terms may vary depending on the intention of a technician working in the field, legal or technical interpretation, and the emergence of new technologies. Also, some terms may be terms arbitrarily selected by the applicant. These terms may be interpreted as defined in this document, and if there is no specific term definition, the terms may be interpreted based on the overall content of this document and common technical knowledge in the art.

In addition, the same reference numerals or numerals in each drawing attached to this document indicate parts or components that perform substantially the same function. For convenience of explanation and understanding, the same reference numerals or symbols will be used in different embodiments. For example, even if all of the components having the same reference numerals are illustrated in a plurality of drawings, the plurality of drawings do not mean an embodiment.

Also, in this document, terms including ordinal numbers such as “first” and “second” may be used to distinguish between components. These ordinal numbers are used to distinguish the same or similar components from each other, and the meaning of the term should not be limitedly interpreted due to the use of these ordinal numbers. For example, elements combined with such ordinal numbers should not be construed as limiting the use order or arrangement order by the number. If necessary, respective ordinal numbers may be used interchangeably. For example, a component described as a first member in this document is referred to by the term, a second member. A component described as a second member may be referred to as a first member.

In this document, singular expressions include plural expressions unless the context clearly indicates otherwise. For example, even if a certain element is expressed in the singular in this document, it should not be interpreted as excluding the provision of a plurality of the corresponding element unless otherwise specified. For example, when it is assumed that a first member is disposed on a frame in an embodiment, unless otherwise specified, the embodiment is not limited to disposing only one first member on the frame, and it should be understood as including the arrangement of two or more first members on a frame.

In this document, the terms “comprise”, “configure” and the like are intended to indicate that there is a feature, number, step, operation, component, part, or combination thereof described herein, and it should be understood that the presence or addition of one or more other features, numbers, steps, operations, components, parts, or combinations thereof is not precluded.

In this document, the X-direction, Y-direction, and Z-direction mean directions parallel to the X-axis, directions parallel to the Y-axis, and directions parallel to the Z-axis illustrated in the drawings, respectively. In addition, unless otherwise specified, the X-direction is a concept that includes both the +X-axis direction and the -X-axis direction, and this is applied to the Y-direction and the Z-direction as well.

In this document, when two directions (or axes) are parallel to each other or perpendicular to each other, the two directions (or axes) are generally parallel or substantially parallel to each other. For example, that the first axis and the second axis are perpendicular to each other means that the first axis and the second axis form an angle of 90 degrees or close to 90 degrees.

Paragraphs beginning with “in an embodiment” in this document do not necessarily mean the same embodiment. Certain features, structures, or characteristics may be combined in any suitable way consistent with this document.

In this document, “configured to” means that a certain component includes the structure necessary to implement a certain function.

Hereinafter, embodiments of the present disclosure will be described in detail with reference to the drawings. However, the spirit of the present disclosure is not limited to the presented examples. For example, a person skilled in the art who understands the spirit of the present disclosure may suggest other embodiments included in the scope of the spirit of the present disclosure through the addition, change, or deletion of elements, but this is also included within the scope of the spirit of the present disclosure.

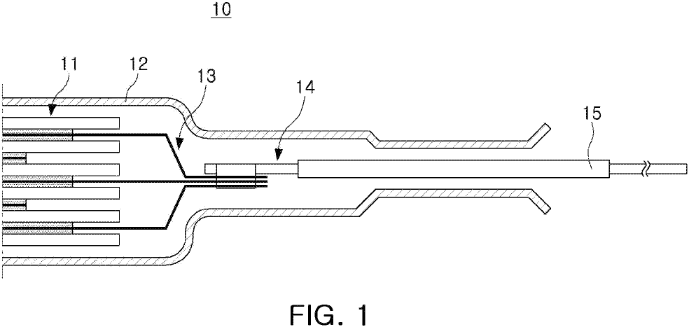

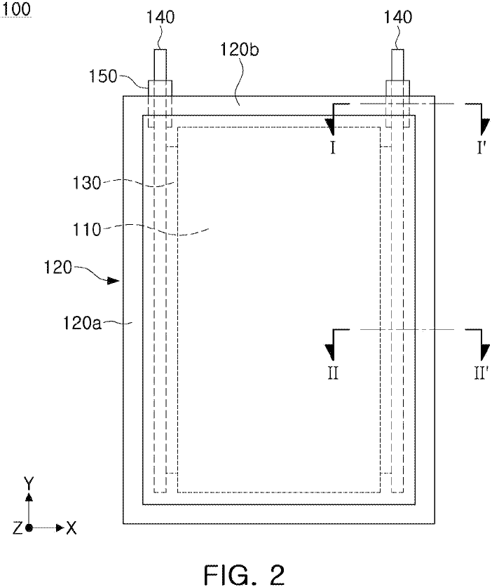

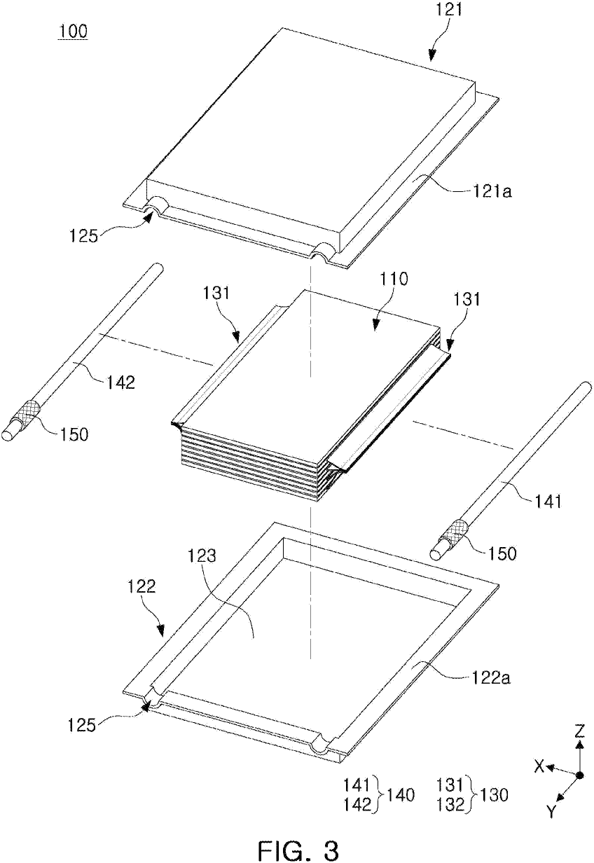

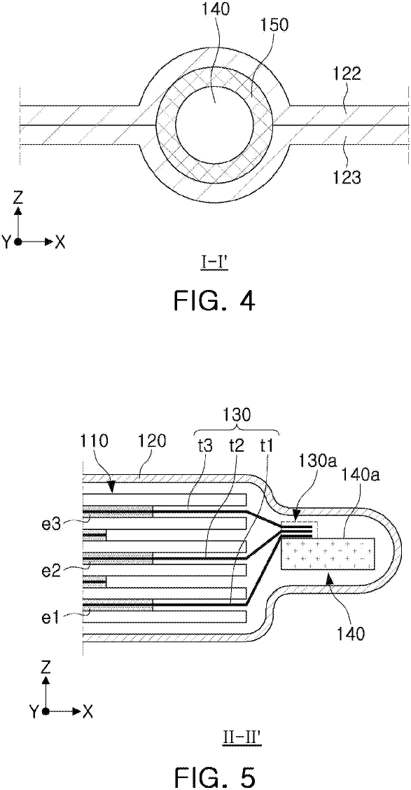

FIG. 2 is a perspective view of a rechargeable battery 100 according to an embodiment. FIG. 3 is an exploded perspective view of a rechargeable battery 100 according to an illustrative embodiment. FIG. 4 is a cross-sectional view taken along line I-I′ of FIG. 1.

Referring to FIGS. 2 and 3, the rechargeable battery 100 includes an electrode assembly 110 and a pouch case 120 surrounding the electrode assembly 110. The pouch case 120 may include a first sheet member 121 covering the upper side of the electrode assembly 110 and a second sheet member 122 covering the lower side of the electrode assembly 110. In the illustrated embodiment, the first sheet member 121 and the second sheet member 122 are distinguished from each other, but this is only an example, and the first sheet member 121 and the second sheet member 122 may respectively be a portion of one sheet member. For example, one sheet member may be folded to cover both sides of the electrode assembly 110, and in this case, a portion of one sheet member, surrounding the upper portion of the electrode assembly 110, may be understood as the first sheet member 121, and a portion thereof surrounding the lower portion of the electrode assembly 110 may be understood as the second sheet member 122.

A plurality of electrodes may be stacked to form the electrode assembly 110. A separator may be disposed between the plurality of electrodes to prevent a short circuit between the electrodes. The electrode is divided into a negative electrode and an anode according to polarity, and the electrode assembly 110 may be formed by alternately stacking a negative electrode and a positive electrode. The electrode may include a current collector and an electrode mixture layer disposed on a surface of the current collector. For example, the positive electrode may include a positive electrode current collector and a positive electrode mixture layer disposed on the surface of the positive electrode current collector. The negative electrode may include a negative electrode current collector and a negative electrode mixture layer disposed on a surface of the negative electrode current collector. The electrode mixture layer may be formed by applying a slurry in which part or all of an electrode active material, a conductive material, a binder, or a solvent is mixed, to the surface of a current collector. The number of electrodes constituting the electrode assembly 110 in the drawings herein is merely an example, and a smaller or larger number of electrodes may constitute the electrode assembly 110.

The rechargeable battery 100 includes an electrode lead 140 drawn out of the pouch case 120. The rechargeable battery 100 may be electrically connected to other rechargeable batteries 100 or other electronic components through the electrode leads 140. For example, electrode leads of rechargeable batteries adjacent to each other may be connected to each other through a connector such as a bus bar. The electrode lead 140 may be divided into a positive lead and a negative lead according to the polarity of the connected electrode.

The electrode and the electrode lead 140 are connected through an electrode tab 130. The electrode tab 130 is drawn toward the electrode tab 130 from the current collector of the electrode. A plurality of electrode tabs 130 extending from a plurality of electrodes are coupled onto the electrode lead 140. For example, the electrode tabs 130 and the electrode lead 140 may be coupled to each other by ultrasonic welding. The electrode tab 130 is divided into a positive tab and a negative tab according to the polarity of the connected electrode. Negative tabs drawn from the negative electrodes are connected to negative leads, and positive tabs drawn from the positive electrodes are connected to positive leads.

Referring to FIG. 3, in an embodiment, a first tab group 131 including at least one electrode tab is drawn out from one side of the electrode assembly 110, and a second tab group 132 including at least one electrode tab is drawn out from the other side thereof. The first tab group 131 and the second tab group 132 are connected to the first electrode lead 141 and the second electrode lead 142, respectively.

The rechargeable battery 100 may include at least one positive lead and at least one negative lead. The negative electrodes/positive electrodes constituting the electrode assembly 110 may be connected to one or more negative leads/negative leads. For example, the rechargeable battery 100 includes a first negative lead and a second negative lead, and two or more electrode tabs may be drawn from one positive electrode, and the electrode tabs may be divided and connected to the first positive lead and the second negative lead.

In an embodiment, the first sheet member 121 and the second sheet member 122 are bonded to each other to seal the inner space 123 in which the electrode assembly 110 is located. Referring to FIGS. 2 and 3, an outer portion 121a of the first sheet member 121 and an outer portion 121b of the second sheet member 122 may be thermally fused to each other to form the sealing portion 120a of the pouch case 120. The sealing portion 120a may be configured to seal the inner space 123 of the pouch case 120 in which the electrode assembly 110 is positioned, from the exterior. The sealing portion 120a may be partially or entirely formed along the edge of the electrode assembly 110. For example, when one sheet is folded and surrounds the electrode assembly 110 in the form of a square plate, a folded portion of the sheet surrounds one side of the electrode assembly 110, and the sealing portions 120a may be formed on the remaining three side surfaces of the electrode assembly 110.

In an embodiment, the electrode lead 140 may be drawn out of the pouch case 120 through the sealing portion 120a. Referring to FIGS. 3 and 4, the first sheet member 121 and the second sheet member 122 are bonded to each other with the electrode lead 140 interposed therebetween. Accordingly, the first sheet member 121 and the second sheet member 122 may partially cover the outer circumferential surface of the electrode lead 140, respectively. For example, the first sheet member 121 and the second sheet member 122 may respectively define a groove 125 corresponding to the shape of the outer circumferential surface of the electrode lead 140. In an embodiment, the electrode lead 140 is provided in the form of a circular rod, such that the outer portions 121a and 122b of the first sheet member 121 and the second sheet member 122 may form a half-pipe-shaped groove 125. However, this is only an example, and in another embodiment, the electrode lead 140 may have a different cross section, and the first sheet member 121 and/or the second sheet member 122 may define a groove 125 having a shape corresponding to the shape of the electrode lead 140.

In an embodiment, a lead film 150 is disposed between the outer circumferential surface of the electrode lead 140 and the pouch case 120. The lead film 150 may prevent a short circuit from occurring between the electrode lead 140 and the metal layer of the pouch case 120, and may improve sealability of the pouch case 120. When heat-sealing the electrode lead 140 formed of metal and the pouch case 120 formed of polymer, the contact resistance is rather high, and surface adhesion may be reduced. The lead film 150 may prevent such deterioration in adhesion. In addition, the lead film 150 is preferably an insulating material that may block current from being applied to the pouch case 120 from the electrode leads. The lead film 150 is formed of a film having insulating properties and heat-sealing properties. The lead film 150 may be formed of material layers (single film or multi film) of one or more selected from, for example, polyimide (PI), polypropylene, polyethylene, and polyethylene terephthalate (PET).

In an embodiment, the electrode tab 130 and the electrode lead 140 may extend in different directions. In an embodiment, the electrode tab 130 may extend from the electrode assembly 110 in a first direction, and the electrode lead 140 may extend in a direction intersecting the first direction. In an embodiment, the electrode tab 130 may extend from the electrode assembly 110 in the first direction, and the electrode lead 140 may extend in a direction perpendicular to the first direction. Referring to FIG. 3, for example, the electrode tab 130 may extend from the electrode assembly 11 in the X-direction, and the electrode lead 140 may extend in the Y-direction.

In an embodiment, the electrode tab 130 may extend in a direction perpendicular to one side of the electrode assembly 110, and the electrode lead 140 may extend parallel to one side of the electrode assembly 110. The electrode lead 140 may be drawn out of the pouch case 120 in an extension direction of the electrode lead 140. For example, referring to FIGS. 2 and 3, the electrode assembly 110 may have a rectangular plate shape surrounded by four mutually perpendicular sides, the electrode tab 130 may extend in the X-direction from one side parallel to the Y-axis, and the electrode lead 140 may extend in the Y-direction parallel to one side of the electrode assembly 110. The electrode lead 140 is drawn out from the pouch case 120 in the +Y-direction.

In an embodiment, the electrode tab 130 may extend from the electrode assembly 110 in a first direction, and the electrode lead 140 may be drawn out of the pouch case 120 in a direction intersecting the first direction. In an embodiment, the electrode tab 130 extends from the electrode assembly 110 in a first direction, and the electrode lead 140 may be drawn out of the pouch case 120 in a direction perpendicular to the first direction. Referring to FIGS. 2 and 3, for example, the electrode tab 130 extends from the electrode assembly 110 in the X-direction, and the electrode lead 140 is drawn out of the pouch case 120 in the Y-direction.

In an embodiment, the electrode tab 130 extends from the electrode assembly 110 in a first direction, and the terrace 120b surrounding the electrode lead 140 in the sealing portion 120a may be located in a direction intersecting the first direction in the electrode assembly 110. In an embodiment, the electrode tab 130 extends from the electrode assembly 110 in the first direction, and in the sealing portion 120a, the terrace 120b surrounding the electrode lead 140 may be positioned in a direction perpendicular to the first direction in the electrode assembly 110. For example, referring to FIGS. 2 and 3, the electrode tab 130 extends in the X-direction from the electrode assembly 110 and the terrace 120b is disposed in the Y-direction of the electrode assembly 110.

In an embodiment, the electrode lead 140 may be provided in the form of a rod or a stick. In the rechargeable battery 100 using a thin plate-shaped electrode lead of the related art, the space consumed for connection between the electrode assembly 110 and the electrode lead 140 is relatively large. The space consumed as described above does not contribute to the capacity of the rechargeable battery 100, and thus has a negative effect on increasing the energy density of the rechargeable battery 100. The energy density refers to the ratio of the volume occupied by the electrode assembly 110 to the total volume of the rechargeable battery 100.

The electrode lead 140 according to an embodiment has a rod or stick shape, which may reduce a space for coupling between the electrode assembly 110 and the electrode lead 140. In addition, by rotating the electrode lead 140 after the electrode tab 130 is welded to the electrode lead 140, the electrode lead 140 may be more closely attached to the electrode assembly 110, which may improve the energy density of the rechargeable battery 100.

In an embodiment, the electrode lead 140 and the electrode tab 130 are in contact with each other over a relatively large area, which may reduce electrical resistance generated while current moves between the electrode and the electrode lead 140. For example, referring to FIGS. 2 and 3, the electrode tabs are drawn out with a width corresponding to one side of the electrode assembly, and the electrode lead is coupled to the electrode tabs over a relatively long length, which may reduce resistance generated when current moves between the electrode and the electrode lead.

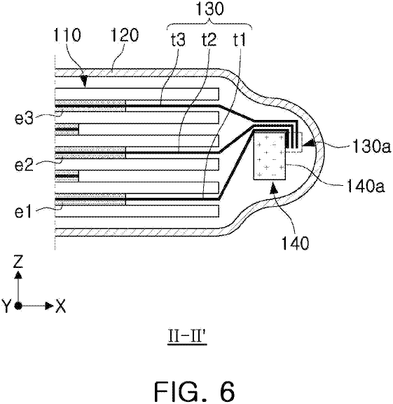

FIGS. 5 and 6 respectively illustrate a detailed coupling structure between the electrode tab 130 and the electrode lead 140 in an embodiment. FIGS. 5 and 6 are examples of cross-sectional views of the rechargeable battery 100 of FIG. 2, taken along line II-II′ . Although the cross section of the electrode lead 140 is illustrated as a rectangle in FIGS. 5 and 6, this is merely an example, and the electrode lead 140 may have a cross section of various shapes. For example, the electrode lead 140 may have a circular cross section as illustrated in FIG. 4.

In an embodiment, a coupling surface 140a of the electrode lead 140 to which the plurality of electrode tabs 130 are coupled may face a direction intersecting the stacking direction of the electrode assembly 110. For example, the plurality of electrode tabs 130 are welded on the coupling surface 140a of the electrode lead 140, and the direction in which the coupling surface 140a faces may be perpendicular to the stacking direction of the electrode assembly 110. For example, referring to FIG. 6, in an embodiment, electrodes e1, e2, and e3 are stacked in the Z-direction, and the coupling surface 140a between the electrode tabs 130 and the electrode lead 140 may face a direction perpendicular to the Z-direction (i.e., the X-direction).

In an embodiment, the plurality of electrode tabs 130 are stacked on each other to form a coupling portion 130a coupled onto the electrode lead 140, and in the coupling portion 130a, the plurality of electrode tabs 130 may be stacked in a direction parallel to or intersecting the stacking direction of the electrodes.

For example, referring to FIG. 5, in an embodiment, the direction in which the electrode tabs t1, t2, and t3 are stacked may coincide with the stacking direction of the electrodes e1, e2, and e3 that are connected to the electrode tabs t1, t2, and t3 respectively. For example, the first electrode tab t1, the second electrode tab t2, and the third electrode tab t3 are drawn out from the first electrode e1, the second electrode e2, and the third electrode e3 sequentially stacked in the +Z-direction, respectively, and the first electrode tab t1, the second electrode tab t2, and the third electrode tab t3 are sequentially stacked on the electrode lead 140 in the +Z-direction.

Referring to FIG. 6, in an embodiment, the direction in which the electrode tabs t1, t2, and t3 are stacked may intersect the stacking direction of the electrodes e1, e2, and e3 connected to the electrode tabs t1, t2, and t3 respectively. For example, the first electrode tab t1, the second electrode tab t2 and the third electrode tab t3 are drawn out from the first electrode e1, the second electrode e2, and the third electrode e3 sequentially stacked in the +Z-direction, respectively, and the first electrode tab t1, the second electrode tab t2, and the third electrode tab t3 are sequentially stacked on the electrode lead 140 in the +X-direction. That the stacking direction of the electrode tabs t1, t2, and t3 disposed on the electrode lead 140 is different from the stacking direction of the electrodes e1, e2 and e3 may be implemented by rotating the electrode lead 140 after the electrode tabs t1, t2, and t3 are coupled on the electrode lead 140. For example, the electrode lead 140 in the state of FIG. 5 may be rotated 90 degrees clockwise to be in the state of FIG. 6.

Referring to FIG. 6, in an embodiment, the plurality of electrode tabs 130 may be partially wound along a portion of the outer circumferential surface of the electrode lead 140. While the electrode lead 140 rotates, at least a portion of the electrode tabs 130 may be rolled along the outer circumferential surface of the electrode lead 140. The plurality of electrode tabs 130 may be partially rolled along the outer circumferential surface of the electrode lead 140 in a section between the coupling portion 130a and the electrode assembly 110. For example, the electrode tabs 130 may cover the electrode lead 140 in a portion other than the coupling portion 130a. The electrode lead 140 is wound, and may thus be located relatively close to the electrode assembly 110, which may contribute to reducing the overall size of the rechargeable battery 100 and increasing an energy density thereof.

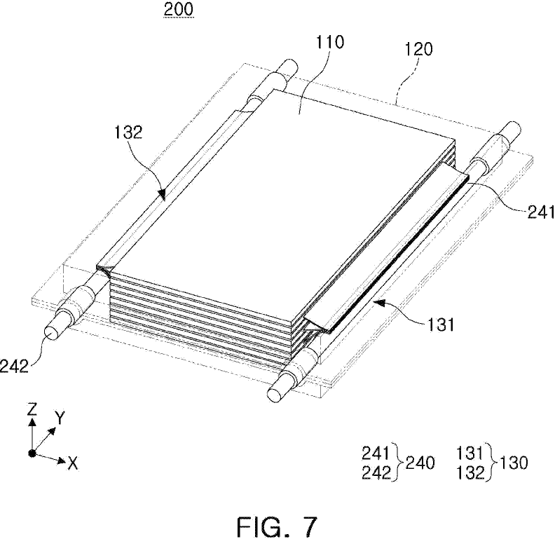

FIGS. 7 to 10 illustrate various rechargeable batteries including rod-shaped electrode leads 140.

FIG. 7 illustrates that one electrode lead is drawn out in both directions from a rechargeable battery 200 in an embodiment. The rechargeable battery 200 of FIG. 7 has a difference in the drawing direction of the electrode leads compared to the rechargeable battery 100 of FIGS. 2 to 6, and except for this difference, some or all of the details described in FIGS. 2 to 6 may also be applied to the rechargeable battery 200 of FIG. 7.

In an embodiment, the electrode lead 240 extends in both directions, and both ends thereof may be drawn out of the pouch case 120. In FIG. 2, the electrode leads 140 are drawn only in the +Y-direction of the pouch case 120. In FIG. 7, the first electrode lead 241 and the second electrode lead 242 are disposed in the +X-direction and the 1X-direction of the electrode assembly 110, respectively, are both extended in the Y-direction, and then drawn out in the +Y and -Y-directions of the pouch case 120.

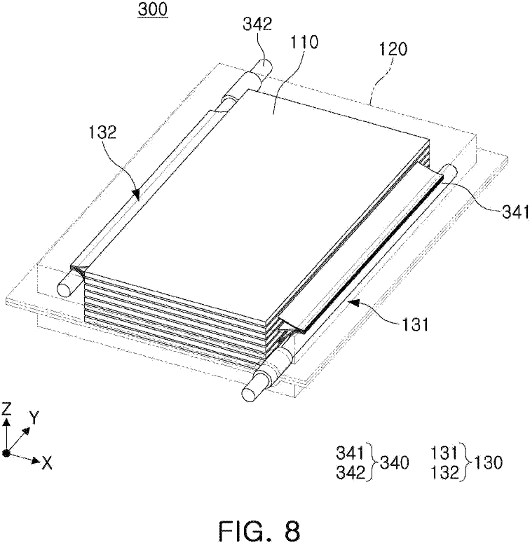

FIG. 8 illustrates a rechargeable battery 300 in which two electrode leads are drawn out in different directions in an embodiment. The rechargeable battery 300 of FIG. 8 has a difference in the drawing direction of electrode leads compared to the rechargeable battery 100 of FIGS. 2 to 6, and except for this difference, some or all of the details described in FIGS. 2 to 6 may also be applied to the rechargeable battery 300 of FIG. 8.

In FIG. 2, the electrode leads 140 are disposed in the -X-direction and the +X-direction of the electrode assembly 110, respectively, are both extended in the +Y-direction, and then, are drawn out in the +Y-direction of the pouch case 120. In FIG. 8, the first electrode lead 341 and the second electrode lead 342 are disposed in the +X-direction and -X-direction of the electrode assembly 110, and extend in the -Y-direction and +Y-direction, respectively, and are then drawn out in the -Y-direction and +Y-direction of the pouch case 120, respectively.

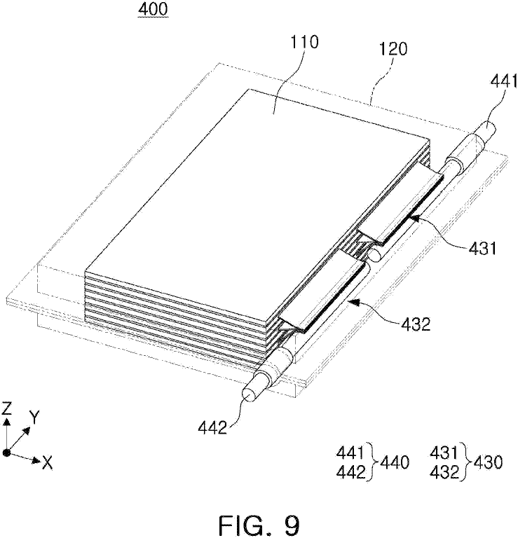

FIG. 9 illustrates that two electrode leads are both disposed on one side of an electrode assembly in an embodiment. A rechargeable battery 400 of FIG. 9 has a difference in the drawing direction of the electrode leads and in that the electrode leads are disposed on only one side of the electrode assembly, as compared with the rechargeable battery 100 of FIGS. 2 to 6. Except for this difference, some or all of the details described in FIGS. 2 to 6 may also be applied to the rechargeable battery 400 of FIG. 9.

The rechargeable battery 400 may include two tab groups drawn out from one side of the electrode assembly 110 and spaced apart in the longitudinal direction of the electrode assembly 110. For example, referring to FIG. 9, a first tab group 431 and a second tab group 432 respectively extend in the +X-direction from one side of the electrode assembly 110, and the first tab group 431 and the second tab group 432 may be spaced apart from each other in the Y-direction. The first tab group 431 and the second tab group 432 may have different polarities. For example, the first tab group 431 may include negative electrode tabs, and the second tab group 432 may include positive electrode tabs. Both the first electrode lead 441 and the second electrode lead 442 are disposed in the +X-direction of the electrode assembly 110 and coupled to the first tab group 431 and the second tab group 432, respectively, and may be drawn out in the +Y-direction and -Y-direction of the pouch case 120, respectively after extending in the +Y-direction and -Y-direction, respectively.

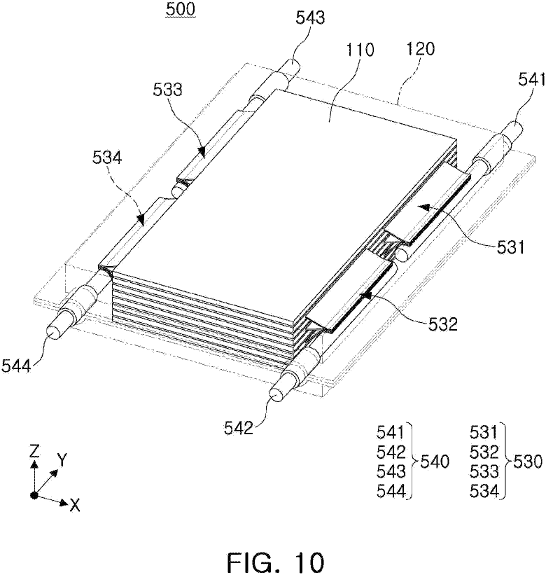

FIG. 10 illustrates a rechargeable battery 500 including four electrode leads 140 according to an embodiment. The rechargeable battery 500 of FIG. 10 is different from the rechargeable battery 100 of FIGS. 2 to 6 in that two electrode leads are disposed on each of both sides of the electrode assembly. Except for this difference, some or all of the details described in FIGS. 2 to 6 may also be applied to the rechargeable battery 500 of FIG. 10.

In an embodiment, the rechargeable battery 500 may include two electrode leads drawn in one direction and electrode leads drawn in the other direction.

For example, the rechargeable battery 500 may include a first electrode lead 541 drawn out in the +Y-direction, a third electrode lead 543 drawn out in the +Y-direction, a second electrode lead 542 drawn out in the Y-direction, and a fourth electrode lead 544 drawn out in the -Y-direction.

The two electrode leads drawn out in one direction may have different polarities. For example, the first electrode lead 541 and the third electrode lead 543 drawn out in the +Y-direction may be a positive lead and a negative lead, respectively.

Among the plurality of electrode tabs, the first tab group 531 and the second tab group 532 are drawn out from a first side of the electrode assembly 110, and the third tab group 533 and the fourth tab group 534 may be drawn out from a second side of the electrode assembly opposite to the first side. For example, the first tab group 531 and the second tab group 532 are drawn out to the side of the electrode assembly 110 in the +X-direction, and the third tab group 533 and the fourth tab group 534 may be drawn out to the side of the electrode assembly 110 in the -X-direction.

The first tab group 531 and the second tab group 532 are coupled to the first electrode lead 541 and the second electrode lead 542, respectively. The third tab group 533 and the fourth tab group 534 are coupled to the third electrode lead 543 and the fourth electrode lead 544, respectively.

Both the first electrode lead 541 and the second electrode lead 542 are disposed in the +X-direction of the electrode assembly 110, extend in the +Y-direction and -Y-direction, respectively, and then drawn out of the pouch case 120 in the +Y-direction and -Y-direction.

The third electrode lead 543 and the fourth electrode lead 544 are both disposed in the -X-direction of the electrode assembly 110, extend in the +Y-direction and -Y-direction, respectively, and are then drawn out in the +Y-direction and -Y-direction of the pouch case 120, respectively.

On the other hand, the rechargeable batteries 100, 200, 300, 400, and 500 in FIGS. 2 to 10 are merely examples of rechargeable batteries to which the present disclosure is applied, and the embodiments herein are not limited thereto.

As set forth above, according to various embodiments, a pouch-type rechargeable battery having relatively high energy density may be provided.

While example embodiments have been shown and described above, it will be apparent to those skilled in the art that modifications and variations could be made without departing from the scope of the present disclosure as defined by the appended claims.

What is claimed is:

1. A rechargeable battery comprising:
an electrode assembly including a plurality of electrodes stacked in a first direction;
a pouch case defining an inner space in which the electrode assembly is accommodated, and including a first sheet member surrounding an upper portion of the electrode assembly and a second sheet member surrounding a lower portion of the electrode assembly;
a plurality of electrode tabs drawn from the plurality of electrodes in a second direction, perpendicular to the first direction; and
an electrode lead combined with the plurality of electrode tabs, extending in a direction, perpendicular to the first direction, and intersecting the second direction, and partially exposed to an exterior of the pouch case,
wherein the first sheet member and the second sheet member are bonded to each other with the electrode lead therebetween to form a sealing portion sealing the inner space.

2. The rechargeable battery of claim 1, wherein the plurality of electrode tabs extend in a direction, perpendicular to one side of the electrode assembly, and the electrode lead extends in parallel to the one side and is drawn out of the pouch case in an extension direction.

3. The rechargeable battery of claim 1, wherein in the sealing portion, a terrace surrounding the electrode lead is located in a direction perpendicular to the second direction from the electrode assembly.

4. The rechargeable battery of claim 1, wherein the electrode lead is provided in a form of a circular rod.

5. The rechargeable battery of claim 1, wherein a coupling surface between the electrode lead and the plurality of electrode tabs faces a direction intersecting the first direction.

6. The rechargeable battery of claim 1, wherein the plurality of electrode tabs are stacked with each other to form a coupling portion coupled onto the electrode lead, and in the coupling portion, the plurality of electrode tabs are stacked in a direction intersecting the first direction.

7. The rechargeable battery of claim 6, wherein the plurality of electrode tabs are partially wound along a portion of an outer circumferential surface of the electrode lead.

8. The rechargeable battery of claim 1, wherein the electrode lead extends in both directions, and both ends are drawn out of the pouch case.

9. The rechargeable battery of claim 1, wherein at least one of the plurality of electrode tabs forms a first tab group, and at least one of the plurality of electrode tabs forms a second tab group, distinct from the first tab group, and
the electrode lead includes a first electrode lead coupled to the first tab group and a second electrode lead coupled to the second tab group.

10. The rechargeable battery of claim 9, wherein the first electrode lead and the second electrode lead extend in the same direction and are drawn out in the same direction from the pouch case.

11. The rechargeable battery of claim 9, wherein the first electrode lead and the second electrode lead extend in directions opposite to each other and are drawn out in opposite directions from the pouch case.

12. The rechargeable battery of claim 9, wherein the first tab group and the second tab group are drawn out from a first side of the electrode assembly, and the first electrode lead and the second electrode lead are disposed on the first side of the electrode assembly, extend in directions opposite to each other, and are drawn out in opposite directions from the pouch case.

13. The rechargeable battery of claim 12, wherein at least one of the plurality of electrode tabs forms a third tab group, at least one of the plurality of electrode tabs forms a fourth tab group, distinct from the third tab group, and the third tab group and the fourth tab group are drawn out from a second side of the electrode assembly, the second side being opposite to the first side, and
the electrode lead further includes a third electrode lead and a fourth electrode lead disposed on the second side of the electrode assembly, and the third electrode lead and the fourth electrode lead extend in directions opposite to each other, and are drawn out in opposite directions from the pouch case.
